(19) United States
(12) Patent Application Publication
(10) Pub. No.: US 2013/0055138 A1
(43) Pub. Date: Feb. 28, 2013

(54) DYNAMICALLY CHANGING KEY SELECTION BASED ON CONTEXT

(71) Applicants: Jonathan Paul de Halleux, Seattle, WA (US); Michal J. Moskal, Seattle, WA (US); Nikolai Tillmann, Redmond, WA (US); Manuel A. Fahndrich, Seattle, WA (US)

(72) Inventors: Jonathan Paul de Halleux, Seattle, WA (US); Michal J. Moskal, Seattle, WA (US); Nikolai Tillmann, Redmond, WA (US); Manuel A. Fahndrich, Seattle, WA (US)

(73) Assignee: Microsoft Corporation, Redmond, WA (US)

(21) Appl. No.: 13/217,306

(22) Filed: Aug. 25, 2011

(51) Int. Cl. G06F 3/048

(52) U.S. Cl. 715/773

(57) ABSTRACT

Editing functionality is described herein for creating a structured data item by dynamically presenting a key arrangement that is deemed suitable at each instance of an editing session. Each key is associated with a component of the structured data item. Upon activation of one of these keys, the editing functionality adds a corresponding component to the item being created. The editing functionality can be implemented on any user device, but is particularly suited for implementation on a handheld computing device having a limited input mechanism and a display mechanism.

### BACKGROUND

In known techniques, a user may create a structured data item using editing functionality implemented on a personal computer or like device. The structured data item has plural components. For example, a user may use editing functionality provided by a personal computer to create a program which comprises a series of statements. In this scenario, the program comprises the structured data item and the program fragments of the program comprise the components. More specifically, the user may use the keyboard of the personal computer to type out, character by character, each program fragment of the program being created. In some cases, the editing functionality also provides menus which allow a user to investigate program fragments that can be added to the program being created. The user can activate such a menu, scan down to find a desired program fragment, and select that fragment to add it to the program being created.

However, the above-described approach is not fully feasible in some technical environments.

### SUMMARY

Functionality is described herein for creating a structured data item (“item”) having plural components. In some implementations, the functionality operates by determining a current position within the item that is being created. That current position corresponds to a current context. The functionality then selects and renders a key arrangement that includes “soft” keys that are deemed appropriate to the current context. That is, the functionality populates the arrangement with the keys that have the greatest chance of being selected by a user in the current context. The functionality then receives the user's activation of one of the keys. In response, the functionality adds a component that corresponds to the activated key to the item being created. This creates a new context, which, in turn, prompts the functionality to select and render a new key arrangement. In this manner, the functionality guides the user through the creation of the item in a user-friendly and efficient manner, at each stage presenting keys that are deemed potentially useful to the user in adding a next component to the item.

In some implementations, the functionality is implemented using, at least in part, a handheld user device having a touch-sensitive display surface.

In some implementations, the structured data item corresponds to a program that can be created by the user device and then executed by the user device. The components of the program correspond to program fragments.

In some implementations, the functionality selects the key arrangement based on suitability information associated with each candidate component. The suitability information quantifies an extent to which the component is deemed a suitable choice for inclusion in the structured data item within the current context.

In some implementations, the functionality can determine the suitability information based on one or more factors associated with respective pieces of information. For example, the functionality can determine the suitability information based on component relevance information which describes a set of components that can be legally selected within the current context. In addition, or alternatively, the functionality can determine the suitability information based on content (if any) that appears before the current position in the item being created and/or the content (if any) that appears after the current position in the item. In addition, or alternatively, the functionality can determine the suitability information based on one or more other items that have already been created by the user and/or by a group of other users. In addition, or alternatively, the functionality can determine the suitability information based on history information that describes a history of selections of components made by the user and/or made by a group of other users. These factors are cited by way of example, not limitation.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows illustrative editing functionality for creating a structured data item (“item”).

FIG. 2 shows a high-level scenario that describes one application of the editing functionality of FIG. 1.

FIG. 3 shows further illustrative details of a key determination module, which is a component of the editing functionality of FIG. 1.

FIG. 4 shows one implementation of the key determination module; this implementation relies on local computing resources.

FIG. 5 shows another implementation of the key determination module; this implementation relies on both local and remote computing resources.

FIG. 6 shows a version of the editing functionality of FIG. 1, here adapted for use in creating a program.

FIGS. 7-18 together show a scenario that describes an application of the editing functionality of FIG. 6.

FIG. 19 shows a procedure that explains one manner of operation of the editing functionality of FIG. 1.

FIG. 20 shows illustrative computing functionality that can be used to implement any aspect of the features shown in the foregoing drawings.

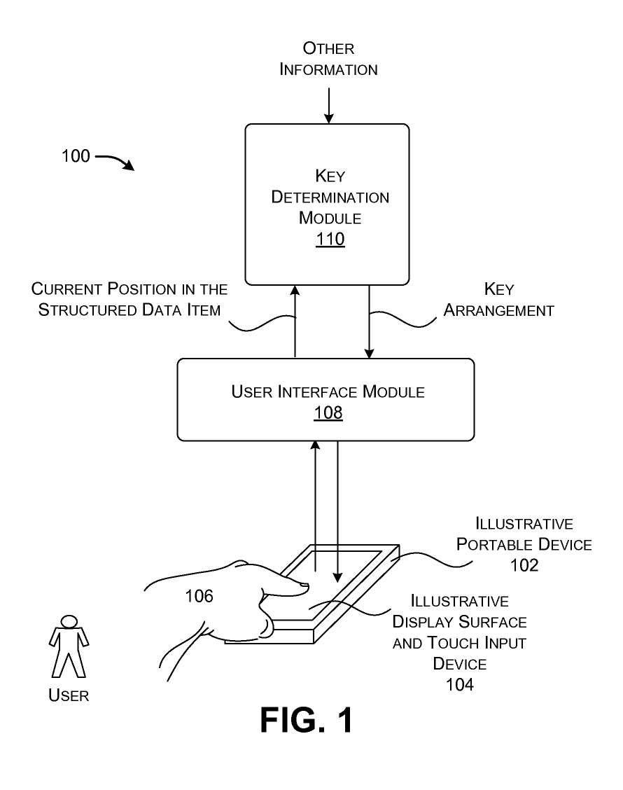

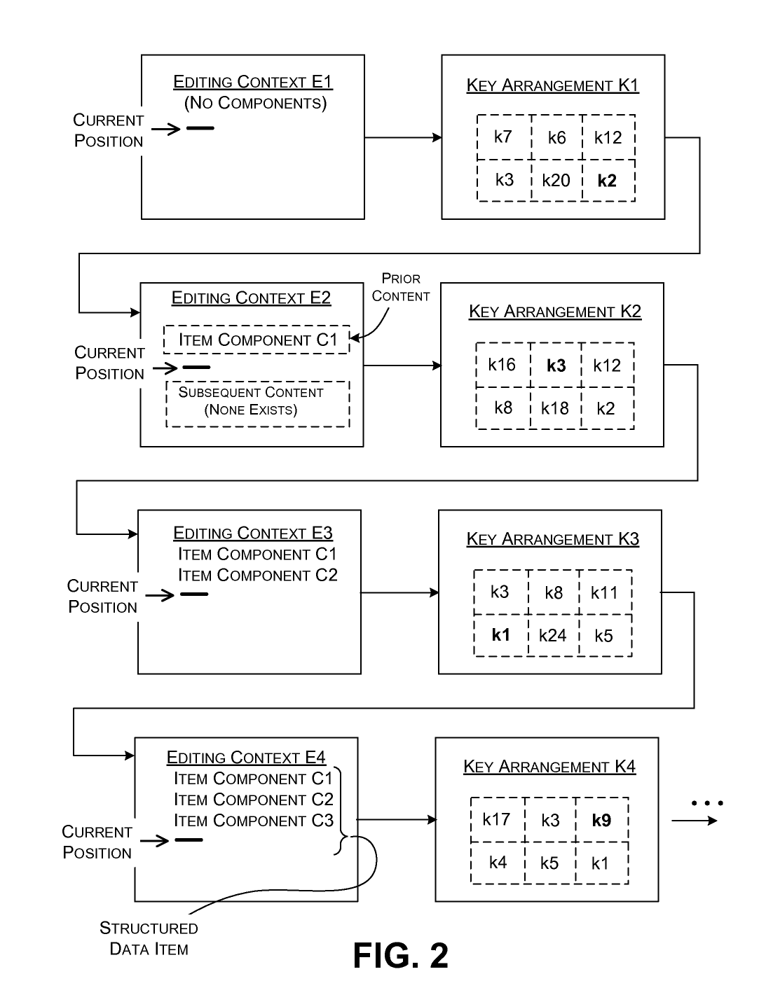

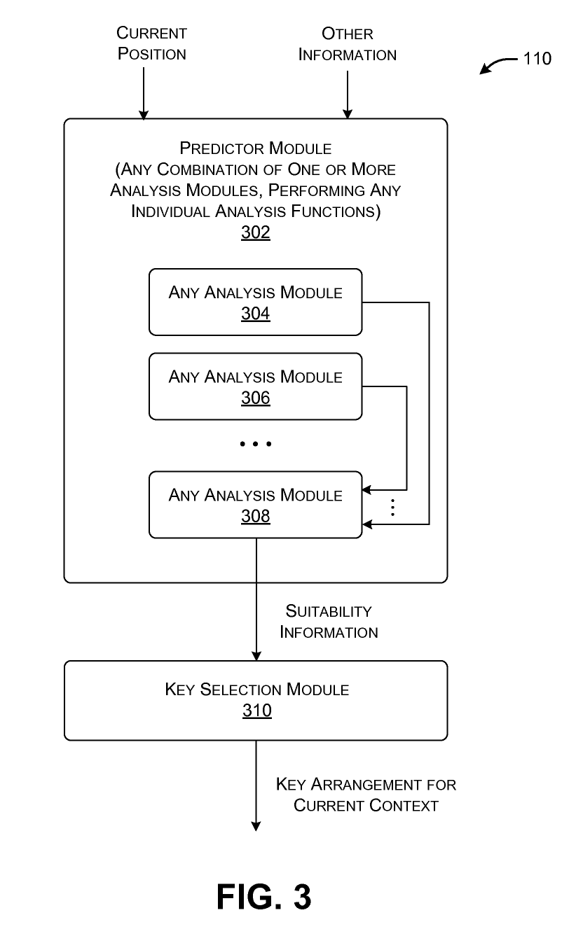

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative editing functionality for creating a structured data item using a dynamically changing key arrangement provided by a user device. Section B describes illustrative methods which explain the operation of the editing functionality of Section A. Section C describes illustrative computing functionality that can be used to implement any aspect of the features described in Sections A and B.

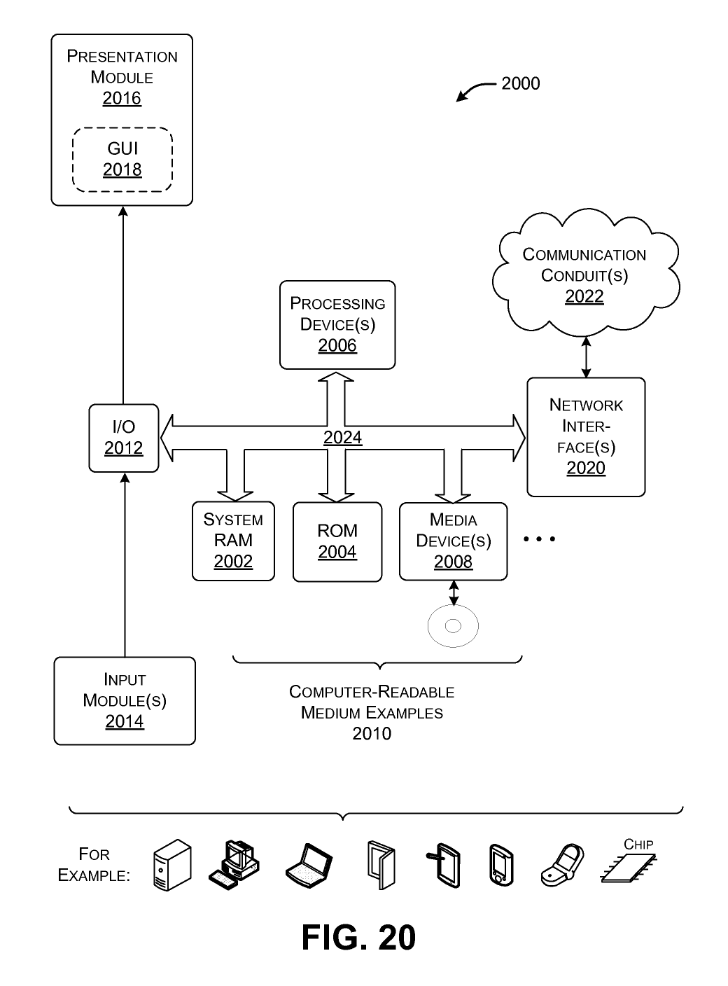

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 20, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Functionality (FIGS. 1-18)

FIG. 1 shows editing functionality 100 for creating a structured data item. As used herein, a structured data item (or just “item” hereafter) refers to content that is composed of multiple components, where some body of rules governs the manner in which the components can be combined together to form a legal and meaningful whole. In one example, an item may correspond to a computer program expressed in any language. The components of the program comprise program fragments, such as APIs, subroutines, method calls, expressions, commands, symbols, etc. The program can be considered as a structured item insofar as the language's rules govern the manner in which the program fragments can be combined together to form an executable program.

In another case, the editing functionality 100 can be used to construct a mathematical expression. Here, the components of the expression correspond to mathematical symbols. In another case, the editing functionality 100 can be used to create a structured record for storage in a database. Here, the components of the item correspond to data elements that are organized into a data structure. In another case, the editing functionality 100 can be used to create a natural language document of any type. Here, the components may correspond to paragraphs, sentences, words, individual characters, etc. These scenarios are cited by way of example, not limitation; other applications of the editing functionality 100 are possible.

In one implementation, the editing functionality 100 is implemented on a handheld user device 102, such as, without limitation, a mobile telephone of any type, a personal digital assistant, an e-book reader device, a handheld game device, and so on. Due to its smaller size (relative to a stationary computing device), the user device 102 may incorporate a limited input mechanism. For example, the user device 102 may include a touch input device which is incorporated into a display surface 104 of the user device 102 in lieu of, or in addition to, a physical keyboard. The user device 102 may programmatically display “soft” keys on the display surface 104 of the user device 102. A user may touch one of these keys using a finger of a hand 106 and/or a stylus (not shown) to activate whatever operation is associated with the key. Alternatively, or in addition, the editing functionality 100 can be implemented in whole or in part by a stationary computing device, such as a personal computer, a set-top box device, a game console device, and so on.

The user device 102 also includes a user interface module 108. The user interface module 108 implements an editing experience which allows a user to create an item, such as a program, within one or more editing sessions. As used herein, the term “creates” includes the case in which the user creates an entirely new item from “scratch,” as well as the case in which the user modifies an existing item to produce a new item.

At certain junctures of an editing session, the user interface module 108 presents a key arrangement on the display surface 104 of the user device 102. The key arrangement includes at least one key. At least some of the keys are associated with candidate components, any of which may be added to the item being created at a designated current position in the item. (The qualifier “candidate” means that the component is a candidate for consideration for inclusion in the item being created.) By pressing a key, the user thereby instructs the user interface module 108 to add an associated component to the item.

A key determination module 110 determines, at each current context, a key arrangement for presentation on the display surface 104 by the user device 102. That is, the key determination module 110 attempts to identify the n candidate components that have the highest likelihood of being selected by the user in the current context, where n equals any number (including a single component). The key determination module 110 can express each candidate component's likelihood of selection using any type of suitability information, such as a numerical suitability score assigned to the candidate component. Based on the suitability information, the key determination module 110 then formulates a key arrangement that includes at least n keys devoted to the identified n candidate components.

The key determination module 110 can draw from any number of factors in determining the suitability of each candidate component. Each factor is associated with a respective piece of information. Illustrative factors are described below.

Context Information.

As one factor, the key determination module 110 can draw from context information. The context information describes the current position in the item at which the user seeks to add a new component. In some cases, the current position is preceded by prior content in the item (e.g., prior program fragments that occur before the current insertion point in a program). In addition, or alternatively, the current position may be followed by subsequent content in the item (e.g., subsequent program fragments that occur after the current insertion point in the program). The context information may include a description of the prior content (if it exists) and/or the subsequent content (if it exists).

Component Relevance Information.

In addition, or alternatively, the key determination module 110 can draw from component relevance information. The component relevance information describes, for each current context, the set of relevant components (if any) which can be meaningfully selected. In other words, the component relevance information describes the universe of possible keys that can be legally selected at a current juncture in the editing session at a designated current position in the item.

Other Item(s).

In addition, or alternatively, the key determination module 110 can draw insights from one or more other items that have been previously created. For example, the key determination module 110 can identify common patterns in the items which indicate the manner in which components have been combined together in the past—as in, for example, an observation that component Q typically follows component P in many items. In one case, the key determination module 110 can examine items that have been created by the particular user who is now creating a new component. In addition, or alternatively, the key determination module 110 can examine any items created by any users within a population of users.

History Information.

In addition, or alternatively, the key determination module 110 can draw from history information that describes the frequency at which certain components have been selected in the past. In one case, the key determination module 110 can consult history information which pertains to selections made by the particular user who is now creating the new component. In addition, or alternatively, the key determination module 110 can examine history information that describes selections made by a plurality of users. The key determination module 110 can extract the history information from the items that have been created in the past. As such, the history information may be considered as a derivable subset of the information imparted by the items. Alternatively, or in addition, the key determination module 110 can generate the history information by dynamically updating the history information each time a user selects a component for inclusion in an item.

The factors identified above are representative, not exhaustive. In other implementations, the key determination module 110 can draw from other factors. In addition, or alternatively, the key determination module 110 can omit one or more factors described above.

In general, FIG. 1 shows that the key determination module 110 receives information regarding the current position and “other information.” The other information may encompass any other data that the key determination module 110 uses to assess the suitability information for the candidate components, such as information regarding other items that have been created by the user (or plural users) in the past.

FIG. 2 shows a high-level scenario that describes one application of the editing functionality 100 of FIG. 1. At the outset, in editing context E1, the item includes no components. Hence, the current position corresponds to an insertion point that marks the location at which the first component of the item will be added. The key determination module 110 can determine a key arrangement K1 that is appropriate for this initial editing context E1 based on any of the factors described above (e.g., context information, component relevance information, prior item(s), history information, etc.). The user interface module 108 then displays the key arrangement K1 on the display surface 104 of the user device 102.

Assume that the user touches one of the keys (e.g., key k2) of the key arrangement K1. This prompts the user interface module 108 to add a first component (component C1) to the item being created. That is, key k2 is associated with component C1, so that pressing key k2 adds component C1 to the item. This establishes editing context E2. The current position in the editing context E2 corresponds to an insertion point that follows the first component C1. The first component C1 now represents prior content in the item. In response to this editing change, the key determination module 110 can determine a new key arrangement K2 that is appropriate for the new editing context E2, based on any of the factors described above.

Assume that the user now presses key k3 in the new key arrangement K2. This prompts the user interface module 108 to add a second component (C2) to the item being creating, producing a new editing context E3. The above-described process continues until the user finishes creating the item. At each juncture, the current position corresponds, by default, to an insertion position that appears at the end of the item. But the user can also move the current position to any point within the body of the item, e.g., to modify a component that has already been created. And for that matter, the user may alternatively begin with an existing item and modify it in a desired manner, e.g., by changing or deleting components within the existing item, adding new components to the existing item, and so on.

Further, in the example of FIG. 2, the insertion point corresponds to a new line which follows the previous line in the item. But, more generally, an insertion point can occur at other locations in the item being created, such as at the end of the previous line. In other words, a single line of the item may include multiple components, corresponding to multiple respective insertion points.

FIG. 3 shows a more detailed view of one implementation of the key determination module 110 of FIG. 1. As shown there, the key determination module 110 can include a predictor module 302 which generates suitability information for each candidate component at each current context in an editing session. The predictor module 302 can receive the current position associated with the current context and “other information,” as described above.

The predictor module 302 itself can be composed of one or more analysis modules (e.g., analysis modules (304, 306, . . . , 308)) connected together in any configuration. The analysis modules (304, 306, . . . , 308) can perform analysis functions that are parts of the overall analysis function performed by the predictor module 302. In one hierarchical configuration, one or more of the analysis modules (304, 306, . . . , 308) can supply results that serve as inputs to one or more other analysis modules. In some implementations, some of the analysis modules (304, 306, . . . , 308) can perform their functions in a dynamic manner in response to each change in context state. In addition, or alternatively, some of the analysis modules (304, 306, . . . , 308) can perform their functions in an offline manner, providing results that are called upon at some later point in time. In some of the implementations, certain analysis modules (304, 306, . . . , 308) can be implemented in a local manner by the user device 102 itself. In addition, or alternatively, some of the analysis modules (304, 306, . . . , 308) can be implemented by remote computing functionality that is accessible to the user device 102 via a network connection (as shown in FIG. 5, to be described below).

To cite one example, at least some of the analysis modules (304, 306, . . . , 308) can generate or otherwise process the different kinds of information described above. For example, one analysis module can identify the prior content and subsequent content with respect to the current position. This constitutes the context information. Another analysis module can identify an entire population of candidate components that can be meaningfully selected in a current context. This information corresponds to relevance information. This analysis module can perform this task by consulting a lookup table which maps the current context to a set of possible components that can be added at this juncture. Another analysis module can recognize patterns in previous items using a classification module that is produced using any type of machine learning technique. In one case, this analysis module can express the patterns in probabilistic terms, e.g., by deriving a conditional probability that a user will choose a candidate component A, given the presence of other components B, C, and D in the item. Another analysis module can generate or otherwise receive the history information, and so on.

A score-calculating analysis module can receive the individual respective results of the above-described contributing analysis modules. Based on these results, the score-calculating analysis module can assign a suitability score to each of the candidate components. More specifically, in one implementation, the suitability score represents a weighted sum that reflects different factors which contribute to the suitability score. For example, one part of the weighted sum can depend on the overall frequency at which the candidate component has been selected in the past, which can be derived from the history information. Another part of the weighted sum can depend on the conditional frequency at which the candidate component appears after (and/or before) some other component which also appears in the item being created, which is an insight that can be derived from other existing items.

A key selection module 310 chooses a key arrangement based on the suitability information generated by the predictor module 302. In one case, the key selection module 310 can assign keys to the n highest ranked candidate components identified by the predictor module 302. The key selection module 310 can then arrange the keys in a key arrangement based on their relevance within this ranking. For example, the key selection module 310 can arrange the keys in a matrix, ordering the keys in the matrix based on relevance. For example, in the key arrangement K1 of FIG. 2, the keys in the matrix are ranked by relevance according to k7>k6>k12>k3>k20>k2 (meaning that the key k7 correspondence to a component having the highest relevance). Alternatively, or in addition, the key selection module 310 can graphically communicate component relevance in other ways, such as by adjusting the size of a key based on the suitability score of its associated component. The key selection module 310 can also organize the keys in other arrangements besides (or in addition to) matrices, such as trees, tag clouds, etc.

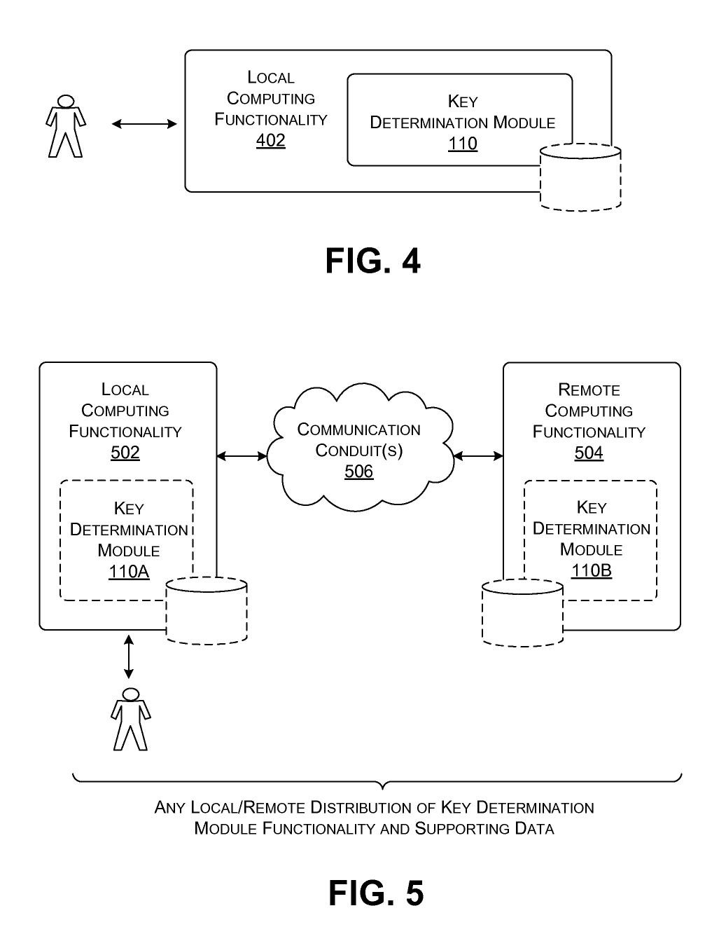

FIG. 4 shows a local implementation of the editing functionality 100, including the key determination module 110. (The other components of the editing functionality 100 are not shown in FIG. 4 to simplify explanation.) That is, in FIG. 4, local computing functionality 402 implements the key determination module 110 and stores all or some of the information that is used by the key determination module 110. The local computing functionality 402 can correspond to the handheld user device 102 shown in FIG. 1.

FIG. 5 shows an implementation of the key determination module 110 which relies on resources provided by both local computing functionality 502 and remote computing functionality 504, which may be coupled together using a communication conduit 506. That is, the local computing functionality 502 can implement key determination module 110A, which performs some functions of the key determination module 110 of FIG. 1. The remote computing functionality 504 can implement key determination module 110B, which performs other functions of the key determination module 110 of FIG. 1. For example, the remote key determination module 110B can perform processor-intensive statistical analysis to determine patterns within a collection of existing items, either in a dynamic manner (when the analysis is called for) and/or in an offline manner. The local key determination module 110A can assign a final suitability score to each candidate component based, in part, on the results provided by the remote key determination module 110B. The information used by the key determination modules (110A, 110B) can also be distributed between the local computing functionality 502 and the remote computing functionality 504 in any manner.

In terms of physical implementation, the local computing functionality 404 can again correspond to the handheld user device 102 shown in FIG. 1. The remote computing functionality 504 can correspond to one or more server computers and associated data stores, provided at one site or distributed over plural sites. In colloquial terms, the remote computing functionality 504 may be implemented as a cloud computing service. The communication conduit 506 can be implemented by any type of local area network, wide area network (e.g., the Internet), etc.

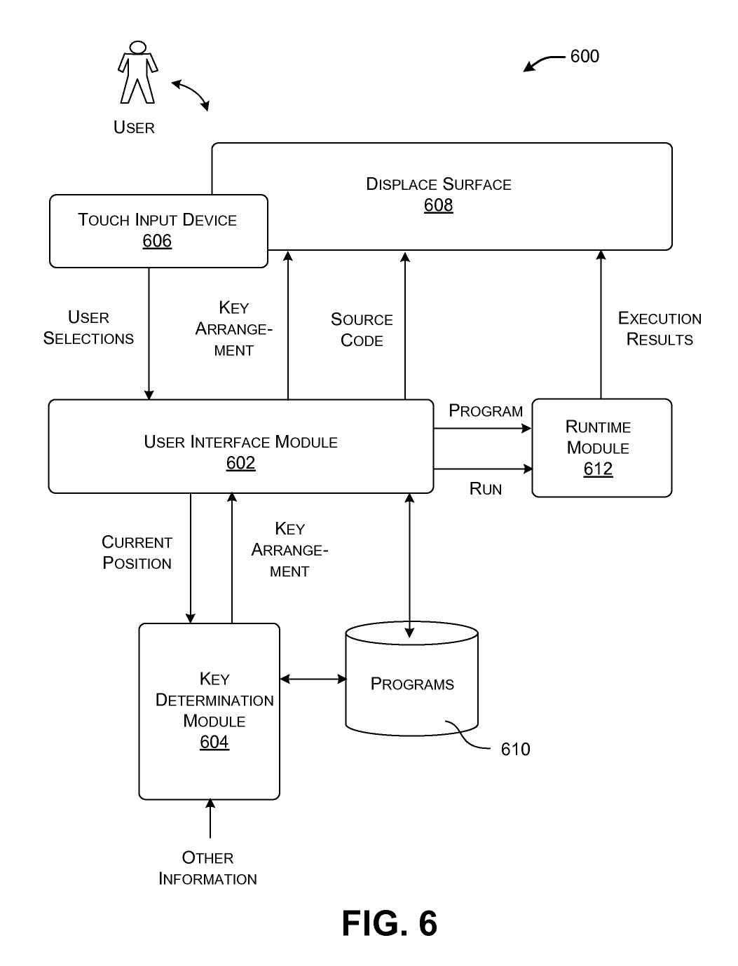

FIG. 6 shows editing functionality 600 that represents a version of the editing functionality 100 of FIG. 1, but here adapted to the case in which the structured data item corresponds to a program being created. The program includes a plurality of program fragments which the user specifies, fragment by fragment, using the editing functionality 600 shown in FIG. 6.

In one implementation, a handheld user device (such as a smart phone or the like) can implement the editing functionality 600. Although, as stated above, a stationary user device (such as a personal computer) can alternatively implement the editing functionality 600, or at least parts of the editing functionality 600.

The editing functionality 600 includes a user interface module 602 which provides an editing experience in the manner described above. The editing functionality 600 also includes a key determination module 604 for selecting a key arrangement for each current context that is encountered. The key determination module 604 can be implemented in the manner described above. The user interface module 602 receives input from a touch input device 606 and provides output to a display surface 104.

A data store 610 can store the program that has been generated using the editing functionality 600. The data store 610 may be local with respect to the user device which implements the editing functionality 600. Alternatively, or in addition, the user may forward the program that he or she has created to a remote data store. In one scenario, the transfer of the program enables the user to share his or her program with other users under any compensation model (including the case in which no fee is charged for the distribution of the program).

A runtime module 612 may execute the program that has been created by the user, or a program that has been received from another source. In one case, the runtime module 612 is local with respect to the user device which implements the editing functionality 600. Alternatively, at least parts of the runtime module 612 can be implemented by remote computing functionality. In any case, the runtime module 612 returns the results of its execution to the user device, where they are displayed on the display surface 608. For example, in one case, the user device can post the results to a “wall,” which corresponds to an interface page devoted to presentation of the results of different programs.

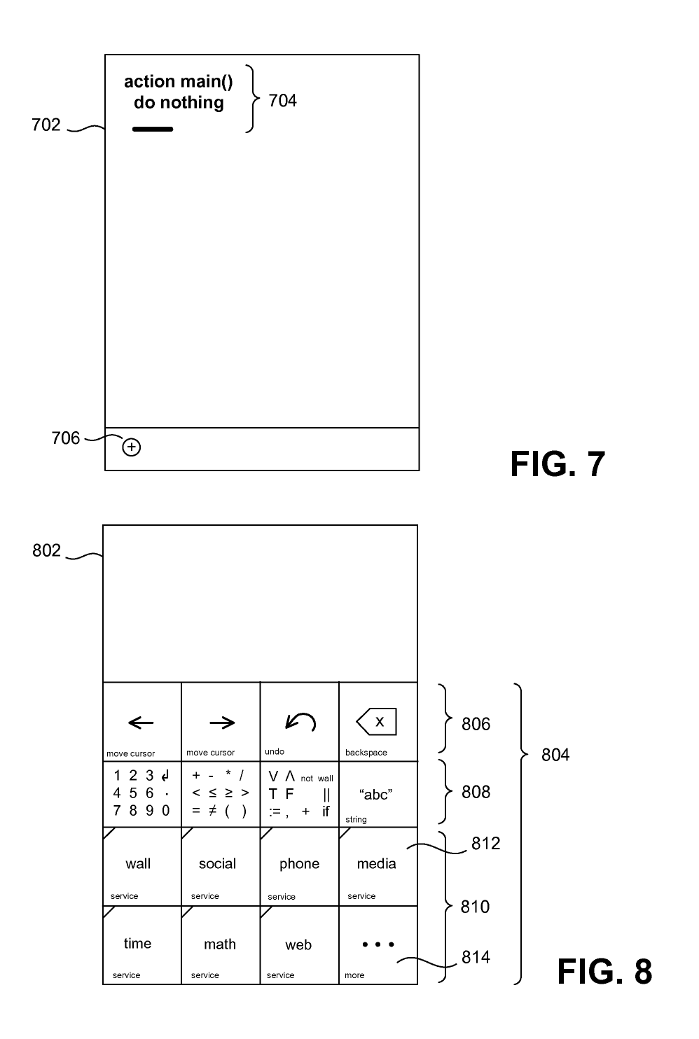

FIGS. 7-18 show a series of user interface presentations that the editing functionality 600 of FIG. 6 can present on the display surface 608 in the course of creating a program. That is, the user interacts with the user interface module 602 to create this program from scratch, starting with a first statement of the program and ending with a final statement of the program. At each juncture in the editing session, the editing functionality 600 presents a key arrangement which suggests a collection of program fragments from which a user may choose.

Starting with FIG. 7, this figure shows an initial interface presentation 702 that displays an initial program fragment 704. The user may activate an add button 706 to add a first program fragment to the program, e.g., by touching that button with his or her finger.

FIG. 8 shows an interface presentation 802 that the editing functionality 600 presents in response to activation of the add button 706. The interface presentation 802 presents an initial key arrangement 804 in a matrix-like calculator format. A first group of keys 806 correspond to editing commands that allow a user to edit the program being created, such as a keys devoted to cursor movement, undo, and backspace. A second group of keys 808 trigger the presentation of other key arrangements devoted to entering particular types of data. For example, a user may activate a first key in this group to enter numerical data, a second key in this group to enter mathematical operators, a third key in this group to enter logical operators, a fourth key in this group to enter text, and so on.

A third group of keys 810 includes keys that have been deemed appropriate for the current context of the editing session—that is, because they are likely to be selected by the user at this juncture in the editing session. Since the user has not yet specified any program fragments, the editing functionality 600 has no program-specific contextual evidence to mine to determine what keys may be appropriate. As such, the editing functionality 600 can select the keys based on the user's history information and/or based on general (user-agnostic) history information. That is, the editing functionality 600 can select keys that this particular user (or all users) has most frequently selected when commencing a program. The editing functionality 600 can order the context-sensitive keys in any manner based on their suitability scores, e.g., in the left-to-right manner described above. However, the editing functionality 600 can use any other approach to organize keys.

In this case, the keys correspond to different general services (e.g., APIs) that perform different functions. Each general service, in turn, can include one or more methods that can be invoked to perform particular operations associated with the general service. In this representative example, assume that the user activates the “media” service assigned to the key 812. This service enables a program to perform various media-related functions.

If the user does not find a desired key in the group of keys 810, he or she can activate a “show more” key 814. This prompts the editing functionality 600 to list additional components that may be selected, e.g., as a list, or as another key matrix, or in some other format. The editing functionality 600 can order the components in this extended list based on any of the factors described above. As a result, the editing functionality 600 can display the most likely components at the top of the list.

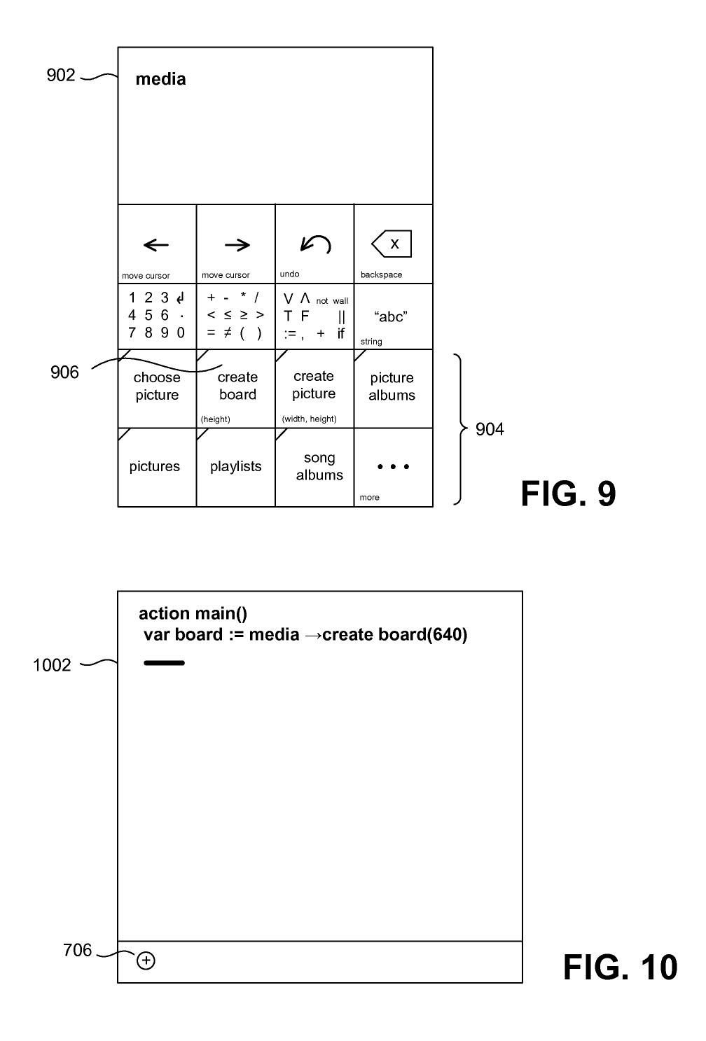

Activation of the media key 812 prompts the editing functionality 600 to present the interface presentation 902 of FIG. 9. The interface presentation 902 includes a new key arrangement with a new group of context-specific keys 904. More specifically, at this juncture, the editing functionality 600 now knows that the user is constructing a program statement that pertains to the media service, so it presents keys associated with methods associated with the media service. Assume that the user activates a key 906 with the label “create board.” This key invokes a method that enables a program to create a graphical window on the display surface 608 of the user device in which graphical objects (e.g., sprites) can be presented and then manipulated by the program.

An interface presentation 1002 shown in FIG. 10 represents the state of the program that is being created after the user: (a) activates the “create board” key 906 of FIG. 9; and then (b) assigns the resultant expression to a local variable named “board,” creating a corresponding board object. The user can perform this assignment in any application-specific manner, such as by activating a menu of possible statement types and selecting a statement type corresponding to an assignment. (Other possible statement types can correspond to if statements, do-while loop statements, etc.) Assume now that the user again activates the add button 706 which prompts the editing functionality 600 to solicit another program fragment from the user.

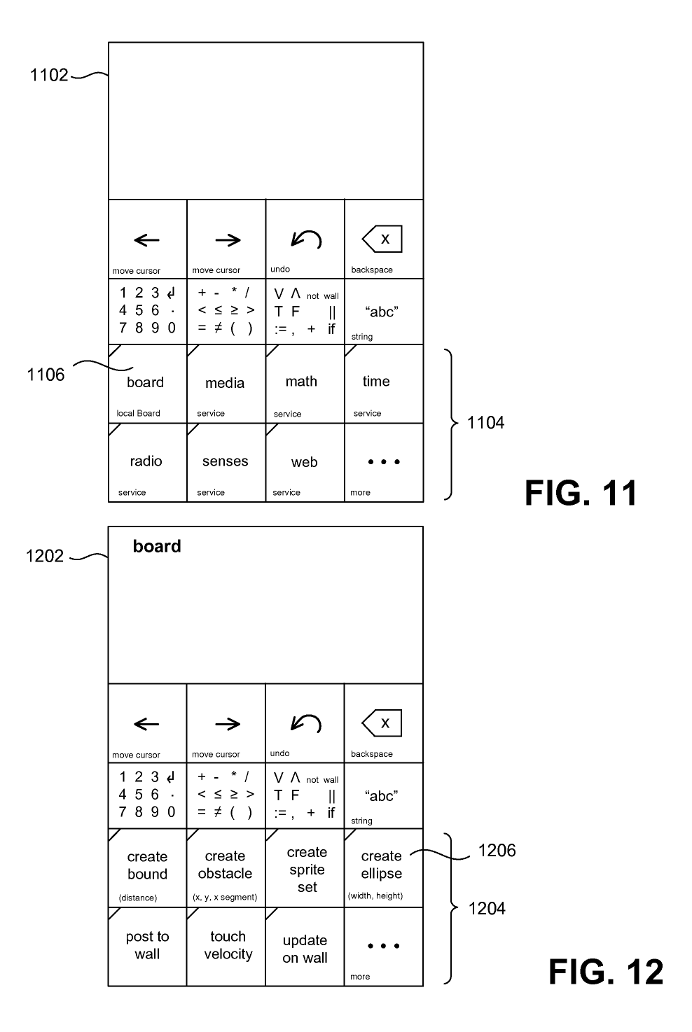

Activation of the add button 706 prompts the editing functionality 600 to present the interface presentation 1102 of FIG. 11, including a new group of context-specific keys 1104. The first key 1106 in that group of keys 1104 corresponds to the local variable “board” that the user has just created, because the editing functionality 600 surmises that the user will most likely wish to add a program fragment which pertains to this object (since the user has just defined this object in the preceding statement). Other keys in the group of keys 1104 correspond to various other functions that the user may wish to invoke. The editing functionality 600 can identify these keys as suitable for inclusion in the key arrangement based on the type of multi-factor analysis described above. At this juncture, assume that the user activates the key 1106 that corresponds to the board object.

Activation of the key 1106 prompts the editing functionality 600 to generate the interface presentation 1202 shown in FIG. 12, including a new group of context-specific keys 1204. The keys 1204 correspond to methods or sub-functions that the user may invoke that pertain to a board object. Assume that the user activates a “create ellipse” key 1206 which corresponds to a method whereby a program can draw an ellipse within the graphical window defined by the board object.

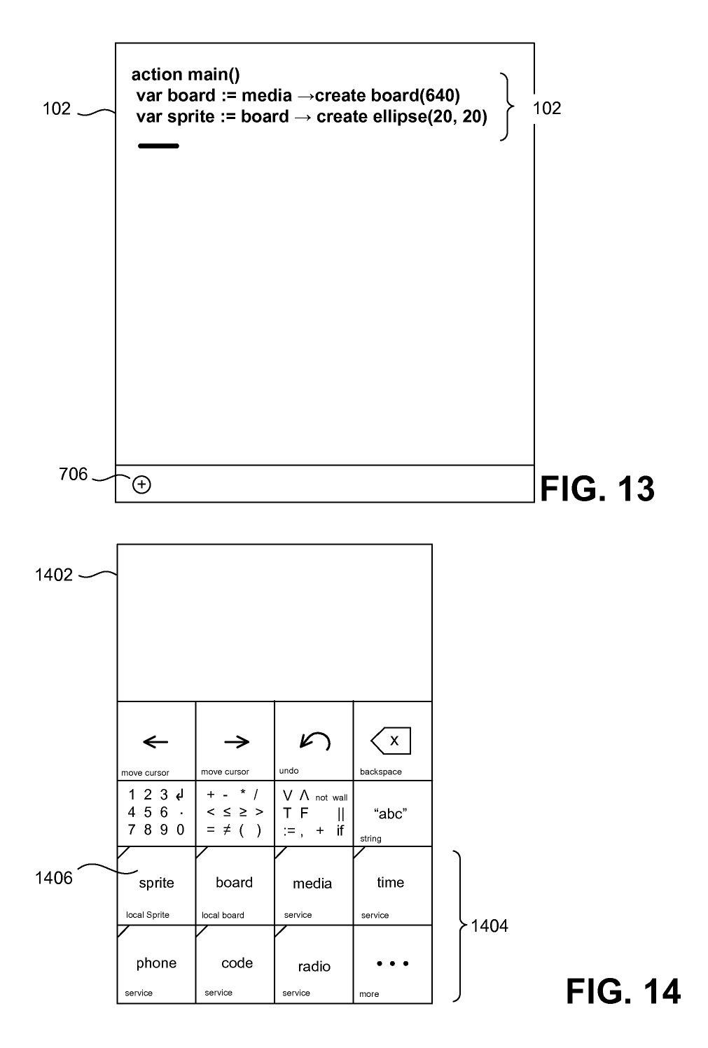

An interface presentation 1302 shown in FIG. 13 represents the state of the program after the user: (a) activates the “create ellipse” key 1206 of FIG. 12; and then (b) assigns the resultant expression to a local variable named “sprite,” creating a sprite object. Assume now that the user again activates the add button 706 which prompts the editing functionality 600 to solicit another program fragment from the user.

Activation of the add button 706 prompts the editing functionality 600 to present the interface presentation 1402 of FIG. 14, including a new group of context-specific keys 1404. The first key 1406 in that group of keys 1104 corresponds to the local variable “sprite” that the user has just created, because the editing functionality 600 surmises that the user will most likely wish to add a program fragment which pertains to this object (since the user has just defined this object in the preceding statement). Indeed, assume that the user does in fact activate this key 1406.

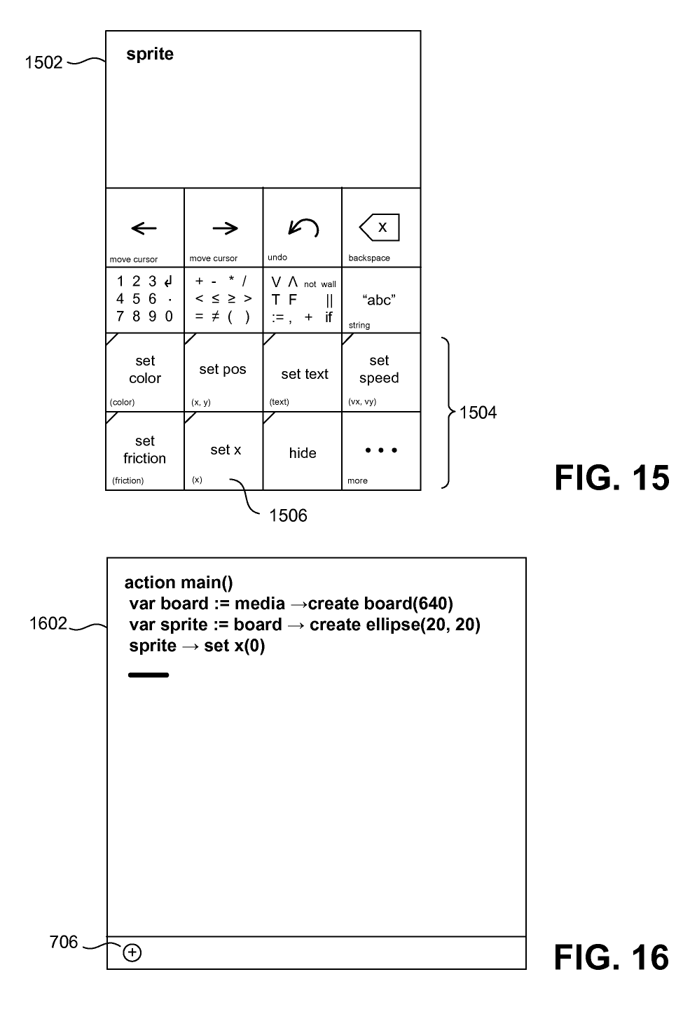

Activation of the key 1406 prompts the editing functionality 600 to generate the interface presentation 1502 shown in FIG. 15, including a new group of context-specific keys 1504. The keys 1504 correspond to different properties that a user may assign to the sprite object that has been created. Assume that the user activates a “set x” key 1506 which corresponds to an instruction to set an x coordinate associated with the location of the sprite object.

An interface presentation 1602 shown in FIG. 16 represents the state of the program after the user activates the “set x” key 1506 of FIG. 15. Assume now that the user again activates the add button 706 which prompts the editing functionality 600 to solicit another program fragment from the user.

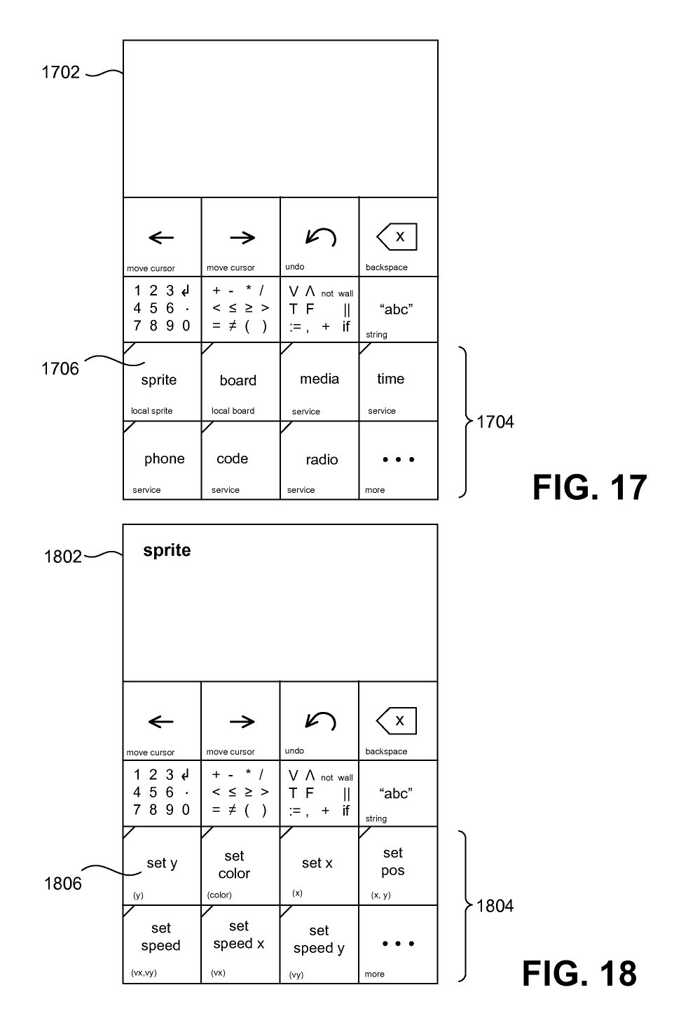

Activation of the add button 706 prompts the editing functionality 600 to present the interface presentation 1702 of FIG. 17, including a new group of context-specific keys 1704. Assume that the user again activates a key 1706 associated with the sprite object that has been created, e.g., so as to define another property of the sprite object.

Activation of the key 1706 prompts the editing functionality 600 to generate the interface presentation 1802 shown in FIG. 18, including a new group of context-specific keys 1804. The keys 1804 again correspond to different properties that a user may assign to the sprite object that has been created. At this juncture, the editing functionality 600 identifies a key 1806, labeled “set y,” as the most likely key that the user will activate next. The editing functionality 600 makes this determination based on the assumption that programmers typically wish to define the y coordinate of a graphical object after they have defined its x coordinate. The editing functionality 600 can make this determination based on any evidence, such as by examining patterns in existing programs created by this particular user or by a general population of users.

A user may continue in the manner described above to add program fragments to the program, fragment by fragment. By virtue of the dynamic and contextual display of key arrangements, the user can enter program fragments with reduced effort. This is compared to the traditional case in which the user is expected to tediously type each program fragment out character by character, or hunt for the name of a program fragment by accessing one or more menus.

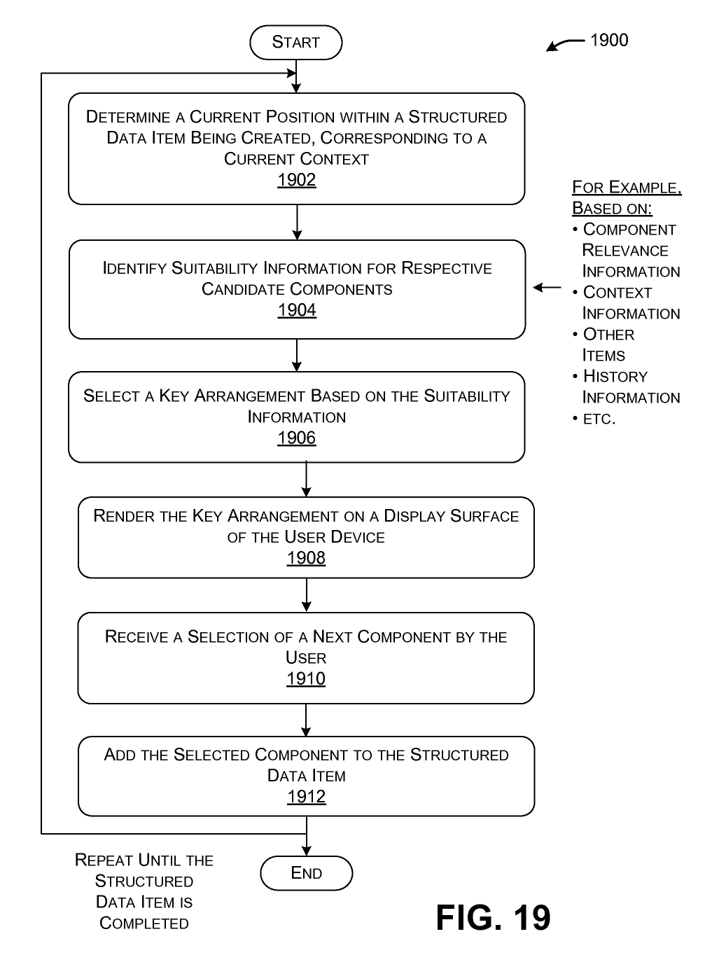

B. Illustrative Processes (FIG. 19)

FIG. 19 shows a procedure 1900 that describes an overview of one manner of operation of the editing functionality 100 of FIG. 1 (as well as the editing functionality 600 of FIG. 6). Since the principles underlying the operation of the editing functionality 100 have already been described in Section A, certain operations will be addressed in summary fashion in this section.

In block 1902, the editing functionality 100 determines a current position within a structured data item (“item”), corresponding to a current context. For example, in some cases, the current position may correspond to a new line of an item that is being created from scratch, or a position at the end of that line. In other cases, the current position may correspond to a position within the body of an item that has already been created, in whole or in part.

In block 1904, the editing functionality 100 identifies suitability information for respective candidate components. For each candidate component, the suitability information defines the likelihood that the user will opt to select this component in the current context. The editing functionality 100 can draw on various factors in determining the suitability information, such as contextual information, component relevance information, one or more prior items that have already been created, history information, and so on. As described in connection with FIG. 3, individual analysis modules may generate or otherwise supply those pieces of information.

In block 1906, the editing functionality 100 selects a key arrangement based on the suitability information defined in block 1904. The key arrangement has at least one key corresponding to a candidate component. In block 1908, the editing functionality 100 renders the key arrangement on the display surface 104 of the user device 102. In block 1910, the editing functionality 100 receives a selection of a next component from a user, e.g., in response to the user's activation of one of the keys in the key arrangement that has been rendered to the display surface 104. In block 1910, the editing functionality 100 adds the selected component to the item that is being created. The loop in FIG. 19 indicates that blocks 1902-1912 can be repeated any number of times until the user has finished creating the item.

C. Representative Computing functionality (FIG. 20)

FIG. 20 sets forth illustrative computing functionality 2000 that can be used to implement any aspect of the functions described above. For example, the computing functionality 2000 can be used to implement any aspect of the editing functionality 100 of FIG. 1, e.g., as implemented in the embodiments of FIG. 4 or 5, or in some other embodiment. In one case, the computing functionality 2000 may correspond to any type of computing device that includes one or more processing devices. In all cases, the electrical data computing functionality 2000 represents one or more physical and tangible processing mechanisms.

The computing functionality 2000 can include volatile and non-volatile memory, such as RAM 2002 and ROM 2004, as well as one or more processing devices 2006 (e.g., one or more CPUs, and/or one or more GPUs, etc.). The computing functionality 2000 also optionally includes various media devices 2008, such as a hard disk module, an optical disk module, and so forth. The computing functionality 2000 can perform various operations identified above when the processing device(s) 2006 executes instructions that are maintained by memory (e.g., RAM 2002, ROM 2004, or elsewhere).

More generally, instructions and other information can be stored on any computer readable medium 2010, including, but not limited to, static memory storage devices, magnetic storage devices, optical storage devices, and so on. The term computer readable medium also encompasses plural storage devices. In all cases, the computer readable medium 2010 represents some form of physical and tangible entity.

The computing functionality 2000 also includes an input/output module 2012 for receiving various inputs (via input modules 2014), and for providing various outputs (via output modules). One particular output mechanism may include a presentation module 2016 and an associated graphical user interface (GUI) 2018. The computing functionality 2000 can also include one or more network interfaces 2020 for exchanging data with other devices via one or more communication conduits 2022. One or more communication buses 2024 communicatively couple the above-described components together.

The communication conduit(s) 2022 can be implemented in any manner, e.g., by a local area network, a wide area network (e.g., the Internet), etc., or any combination thereof. The communication conduit(s) 2022 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by computing functionality, for creating a structured data item having plural components, comprising:
determining a current position within a structured data item being created, the current position corresponding to a current context;
identifying suitability information that describes, for each candidate component within a set of candidate components, a suitability of the candidate component for inclusion in the structured data item within the current context;
selecting a key arrangement based on the suitability information, the key arrangement having at least one key corresponding to a respective candidate component;
rendering the key arrangement on a display surface of a user device;
receiving a selection of a next component in response to activation, by the user, of a key in the key arrangement, to provide a selected component;
adding the selected component to the structured data item; and
repeating said determining, identifying the suitability information, selecting, rendering, receiving, and adding at least one time.

2. The method of claim 1, wherein the user device comprises a handheld user device.

3. The method of claim 1, wherein the structured data item comprises a program, and wherein the plural components of the structured data item comprise program fragments of the program.

4. The method of claim 1, wherein the suitability information is based on, at least in part, component relevance information which describes a set of components that can be legally selected within the current context.

5. The method of claim 1, wherein the suitability information is based on, at least in part, context information that identifies prior content, if any, in the structured data item with respect to the current position.

6. The method of claim 1, wherein the suitability information is based on, at least in part, context information that identifies subsequent content, if any, in the structured data item with respect to the current position.

7. The method of claim 1, wherein the suitability is based on, at least in part, at least one other structured data item created by the user.

8. The method of claim 1, wherein the suitability information is based on, at least in part, other structured data items created by a plurality of users.

9. The method of claim 1, wherein the suitability information is based on, at least in part, selection patterns exhibited in a plurality of structured data items.

10. The method of claim 1, wherein the suitability information is based on, at least in part, history information that describes a history of selections of components by the user.

11. The method of claim 1, wherein the suitability information is based on, at least in part, history information that describes a history of selections of components by plurality of users.

12. The method of claim 1, wherein said rendering comprises rendering the key arrangement as a matrix of keys on the display surface of the user device.

13. The method of claim 12, wherein at least one key invites the user to explore additional candidate components that are not currently represented by the matrix of keys.

14. A handheld user device, comprising:
a display surface for displaying information;
a touch-sensitive input device, integrated with the display surface, for inputting information;
an interface module for providing an editing experience to the user that enables the user to create a structured data item having plural components; and
a key determination module for determining a key arrangement for presentation by the interface module on the display surface, the key determination module determining the key arrangement based on one or more of:
context information that describes a current position within the structured data item, the current position corresponding to a current context;
component relevance information which describes a set of components that can be legally selected within the current context;
selection patterns exhibited in a plurality of structured data items; and
history information that describes a history of selections of components.

15. The user device of claim 14, wherein the structured data item comprises a program, and wherein the plural components of the structured data item comprise program fragments of the program.

16. The user device of claim 14, wherein the context information identifies prior content, if any, in the structured data item with respect to the current position.

17. The user device of claim 14, wherein the context information identifies subsequent content, if any, in the structured data item with respect to the current position.

18. The user device of claim 14, wherein the key determination module determines the key arrangement based on all of the context information, component relevance information, selection patterns, and history information.

19. A computer readable storage medium for storing computer readable instructions, the computer readable instructions providing editing functionality when executed by one or more processing devices of a user device, the computer readable instructions comprising:
logic for determining a current position within a program that is being created, associated with a current context;
logic for identifying suitability information that describes, for each candidate program fragment within a set of candidate program fragments, a suitability of the candidate program fragment for inclusion in the program within the current context;
logic for selecting a key arrangement based on the suitability information, the key arrangement having at least one key corresponding to a candidate program fragment;
logic for rendering the key arrangement on a display surface of a portable user device;
logic for receiving a selection of a next program fragment in response to activation, by the user, of a key in the key arrangement, to provide a selected program fragment; and
logic for adding the selected program fragment to the program.

20. The computer readable storage medium of claim 19, wherein said logic for identifying the suitability information identifies the suitability information based on at least:
context information that describes prior content and subsequent content in the program with respect to the current position, if the prior content and the subsequent content exist;
component relevance information which describes a set of components that can be legally selected within the current context;
selection patterns exhibited in a plurality of programs; and
history information that describes a history of selections of program fragments.
